(19) United States
(12) Patent Application Publication
(10) Pub. No.: US 2024/0112517 A1
(43) Pub. Date: Apr. 4, 2024

(54) MEDIA APERTURE PROTECTION FOR MEDIA HANDLING DEVICES

(71) Applicant: NCR Corporation, Atlanta, GA (US)

(72) Inventors: Jamie Shanks, Dundee (GB); Niall Angus Macrae Afrin, Perth (GB); Eugene Carino Cawit, Consolazion (PH); Jenice Gecana Lausa, Minglanilla (PH); Karen Alfeche Torrejos, Cebu City (PH)

(21) Appl. No.: 17/955,809

(22) Filed: Sep. 29, 2022

(51) Int. Cl. G07D 11/40; G07D 11/14; G07D 11/225

(52) U.S. Cl. CPC G07D 11/40; G07D 11/14; G07D 11/225; G07D 2211/00

(57) ABSTRACT

A shutter module of a media handling device is provided. The module includes a shutter blade and a fan. The shutter blade includes a hollow interior compartment designed to house air pumped into the compartment by the fan and to expel the air out through a vent in the blade when the blade is in an open position. The expelled air creates an air shield with the air being directed away from an aperture to prevent debris from entering the aperture when the blade is opened. The blade, when a closed position, covers the aperture sealing and protecting a media deposit/dispense slot of the media handling device from access. In an embodiment, the fan is continuously pumping air into the compartment when the blade is in the open position to expel the air out the vent and when the blade is in the closed position to keel the compartment pressurized.

### BACKGROUND

In many regions of the world, dust, sand, and dirt can enter through card and receipt slots of Automated Teller Machines (ATMs). However, currency infeed/dispense slots have the largest externally-facing gaps on an exterior surface of an ATM's media handling device. Because of this, many media handling devices include shutters that cover the currency infeed/dispense slots and which only open when currency/checks is/are being deposited or when currency is being dispensed during transactions at the ATMs.

Foreign objects that enter through the infeed/dispense slots of a media handling device can disrupt operation of an ATM by causing jams along the internal media transport paths and/or causing jams in gears or components of the media handling modules within the media handling device. Although most foreign objects come in through the physical environment of the ATM as dirt, sand, dust, or other debris, some foreign objects are intentionally inserted into the slots by thieves and/or customers. Some media handling devices are equipped with sensors to detect intentionally inserted foreign objects; however, these sensors are looking for objects that are much larger than the objects that come in from the environment of the ATM.

Yet, foreign objects sucked into the infeed/dispense slots from the ATM's environment occur nearly every time a transaction at the ATM causes the infeed/dispense slot to open. These objects may be very small, but they accumulate over time within the media handling device and components of its media handling modules. Consequently, ATM service calls are frequently associated with clearing dust, dirt, sand, and debris accumulated inside the media handling device.

### SUMMARY

In various embodiments, a shutter assembly, a media handling device with the shutter assembly, and a method operating the shutter assembly is presented. The shutter assembly includes a hollow manufactured shutter blade through which air can be forced out of an air vent of the shutter when the shutter is in an open position. A backside of the shutter blade includes two inlets, A first inlet permits the hollow inside of the blade to receive air provided by a fan through tubing. The second inlet permits the air pressure within the hollow inside of the blade to be monitored by a pressure gauge via tubing. When the shutter blade is in an open position an aperture associated within a deposit/dispense slot of the media handling device is revealed and the fan pumps are into the hollow inside of the blade where the air is forced out through a vent of the blade creating an air curtain shield for the aperture of the deposit/dispense slot to prevent sand, dirt, and other debris from entering the slot. When the blade is in a closed position, the pressure of the air within the hollow inside of the blade is monitored via the pressure gauge such that if the shutter blade is tampered with a fluctuation in the pressure is detected and security measures can be taken to protect the media handling device.

### BRIEF DESCRIPTION OF THE DRAWINGS

FIG. 1A are diagram of a prior art shutter in a closed position and open position for media deposit/dispense slot of a media handling device associated with an automated teller machine (ATM), according to an example embodiment.

FIG. 1B is a diagram of a shutter assembly/module of a media handling device, according to an example embodiment.

FIG. 1C is a diagram of a shutter for the shutter assembly/module of the media handling device, according to an example embodiment.

FIG. 1D is a diagram illustrating a backside of the shutter assembly/module with a fan and a pressure gauge attached to inlets of the shutter, according to an example embodiment.

FIG. 1E is a diagram a portion of the frontside of the shutter assembly/module illustrating air being forced out of an air vent of the shutter when the shutter is in an open position, according to an example embodiment.

FIG. 2 is a diagram of a media handling device having the shutter assembly/module, according to an example embodiment.

FIG. 3 is a flow diagram of a method for operating the shutter assembly/module within a media handling device, according to an example embodiment.

### DETAILED DESCRIPTION

As stated above, apertures associated with deposit/dispense slots of media handling devices often permit sand, dirt, and debris to enter into the media handling device when the shutters to the slots are opened for a transaction. Accumulation of the debris within the media handling device causes a variety of electrical and mechanical problems for the media handling device which necessitates service calls to clean the modules and components associated with the media handling device.

The teachings provided herein solve these issues and additionally provide security features to the deposit/dispense slots of media handing devices. A novel shutter assembly (hereafter referred to as “shutter module”) is provided. The shutter module includes a shutter blade with a hollow inside compartment adapted to house and dispense air through an air vent of the blade. The shutter blade includes an air inlet for receiving air pumped by a fan and a pressure gauge inlet for monitoring the air pressure inside the compartment of the blade. When the blade is opened in response to a transaction being performed on the media handling device, the fan pumps air into the compartment and the air is forced out an air vent of the blade. This creates an air shield that protects the aperture associated with a deposit/dispense slot of the media handling device such that sand, dirt, and debris is prevented from entering the aperture because of the force of air being directed away from the aperture of the slot when the shutter blade is in the open position.

When the shutter blade is in a closed position, such that the aperture to the slot is covered, a pressure gauge monitors the air pressure inside the compartment of the blade. When the pressure deviates from a range of expected pressures, an event can be raised to cause the media handling device to institute security procedures, such as shuttling down the media handling device, canceling a transaction in progress, activating a security camera, raising the event or a different event to a security system, etc.

As used herein, a “media handling device” is a composite peripheral device to a transaction terminal that includes a variety of modules for handling valuable media, such as currency, coins, and checks during transactions at the transaction terminal. By way of example only, the modules of the media handling device can include a shutter module, an infeed module, a reject box module, an escrow module, an upper transport module, a bill validator (BV) module, a pocket separator module, an upper base module, an intermedia transport module, a lower transport module, a coin deposit/dispense module, a current deposit/dispense module, a cassette holder module, a deposit cassette module, a card reader module, a Personal Identification Number (PIN) pad module, an encrypted PIN pad module, a recycle cassette module, a lower module, and an upper module. The transaction terminal can include an automated teller machine (ATM), a self-service terminal (SST), a point-of-sale (POS) terminal, or a kiosk. In an embodiment, the media handling device is a depository, a dispenser, or a recycler.

The transaction terminal includes the media handling device as a composite peripheral, however, the transaction terminal may include other peripherals such as, by way of example only, a bag weigh scale, a produce weigh scale, a touch display, a handheld scanner, a bioptic scanner, a vertical scanner, a horizontal scanner, a receipt printer, a keypad, etc.

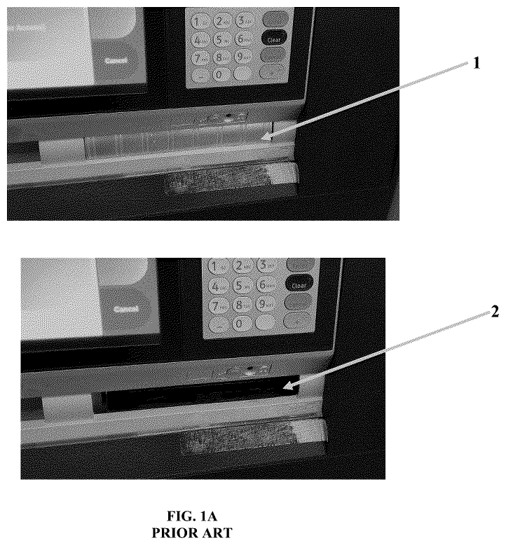

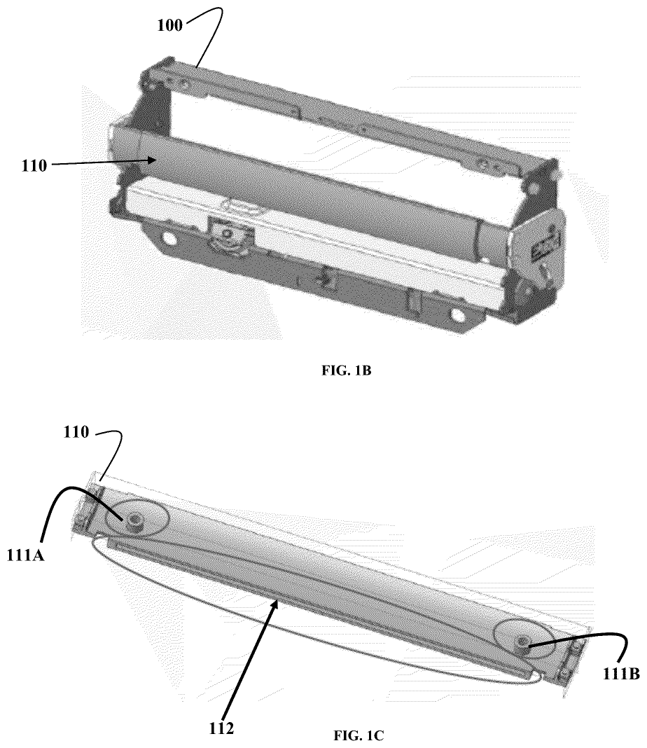

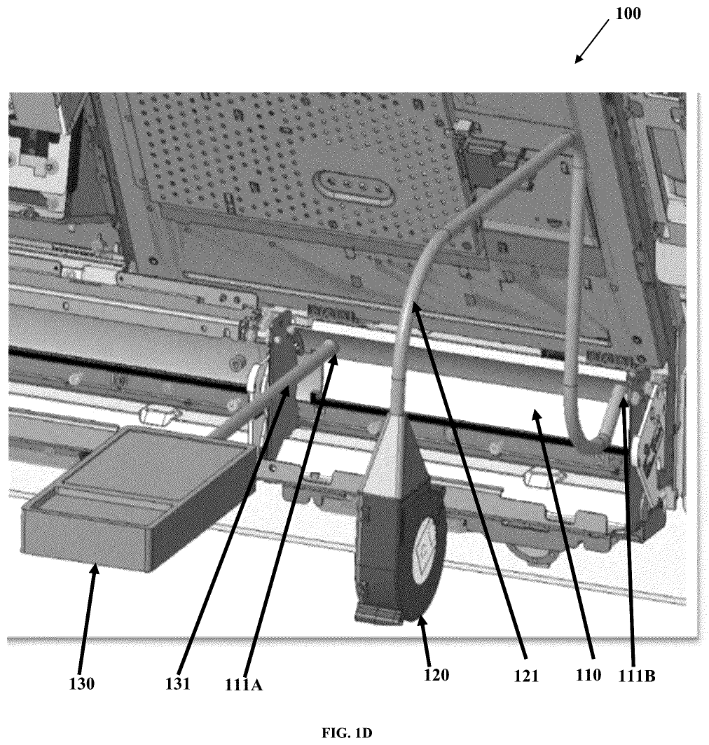

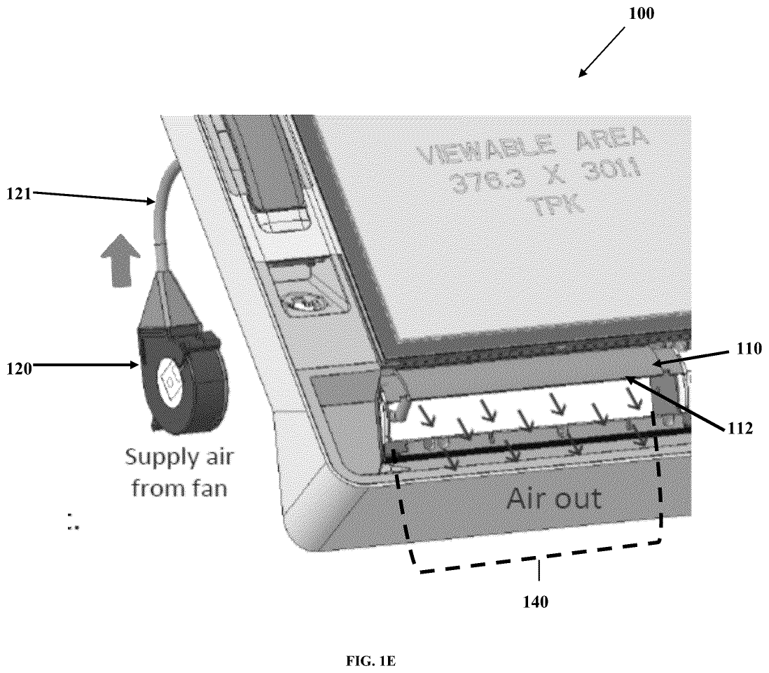

FIG. 1A are diagram of a prior art shutter in a closed position and open position for media deposit/dispense slot of a media handling device associated with an ATM (e.g., one type of transaction terminal), according to an example embodiment. A conventional shutter 1 is illustrated in the top diagram of FIG. 1A. Shutter 1 is in a closed position, such that the aperture associated with the media deposit/dispense slot is covered. Shutter 1 is opened during a transaction at the ATM, as shown in the bottom diagram of FIG. 1A.

When shutter 1 is opened, aperture 2 is visible and provides access for depositing checks/currency and/or for receiving dispensed currency through the deposit/dispense slot. Shutter 1 is opened through control of the ATM when a transaction at the ATM is expected to receive currency or checks for a deposit and when the transaction at the ATM is expected to dispense currency through the deposit/dispense slot. When no transaction is being processed at the ATM, the ATM maintains the shutter 1 in the closed position as illustrated in the top diagram of FIG. 1A. The ATM causes shutter 1 to open only during a portion of a transaction where checks or currency are expected to be received or currency is being dispensed through the deposit/dispense slot.

It is to be noted that although a single deposit/dispense slot is discussed herein that a given media handling device may have multiple different deposit/dispense slots. For example, one slot may be for receiving deposits and another slot may be for dispensing currency. As another example, a separate slot may be for dispensing coins. When multiple media slots are available for a given media handling device, the media handling device may have multiple shutter modules; a shutter module for each slot.

FIG. 1B is a diagram of a shutter module 100 of a media handling device, according to an example embodiment. Only those components relevant to understanding and comprehending the shutter module 100 are labeled and discussed herein and below. Shutter module 100 includes shutter blade 110. A backside of blade 110 is illustrated in FIG. 1C.

Blade 110 is manufactured as a shell that includes an air tight interior compartment adapted to store air pumped into the compartment. Blade 110 also includes three apertures for a pressure gauge inlet 111A, an air inlet 111B, and an air vent 112. Vent 112 extends for substantially the length of a front-facing side of blade 110.

In an embodiment, the size and dimensions of blade 110 are such that an existing shutter module can be retrofitted with blade 110 by replacing the existing blade of the existing shutter module with blade 110. The existing shutter may be further modified to include pressure gauge 130, fan 120, and tubes 131 and 121, discussed below with FIG. 1D.

FIG. 1D is a diagram illustrating a backside of the shutter module 100 with a fan 120 and a pressure gauge 130 attached to inlets 111A and 111B of the shutter blade 110, according to an example embodiment.

Pressure gauge 130 is attached via tube 131 to pressure gauge inlet 111A on the backside of blade 110. Fan 120 is attached via tube 121 to air inlet 111A of blade 110. Fan 120 and/or gauge 130 can receive power from power that is supplied through the media handling device to shutter module 100.

FIG. 1E is a diagram a portion of the frontside of the shutter module 100 illustrating air being forced out of air vent 112 of shutter blade 110 when the shutter blade 110 is in an open position, according to an example embodiment. In an embodiment, Fan 120 is activated when blade 110 is opened to pumps air through tube 121 into air inlet 111A and the hollow interior compartment of blade 110 where the air is forced out of vent 112. This creates an air force field adjacent to and in front of aperture 114 associated with a deposit/dispense slot of the media handling device. The forced air blows in a direction away from the aperture 114 this prevents sand, dirt, and other debris from entering the aperture and the deposit/dispense slot while the blade 110 is opened. In an embodiment, fan 120 is continuously running when the blade is in the closed position and when the blade is in the open position.

Additionally, when the blade 110 is in the closed position, such that the aperture to the deposit/dispense slot is covered by blade 110, pressure gauge 130 monitors the air pressure within the hollow interior compartment of blade 110. Firmware or software can execute on a processor associated with the media handling device and/or shutter module 100 to activate and to deactivate fan 120 after the blade 110 is closed in order to maintain a desired amount of pressure as reported by gauge 130.

The firmware or software can monitor the pressure inside the compartment when the blade 110 is closed using gauge 130 and when a threshold expected range of pressures is deviated from, the firmware or software can raise an event or an alert, which can cause other software of the media handling device and/or the transaction terminal to process security actions, since a deviation in the air pressure can be an indication that someone is attempting to tamper with the deposit/dispense slot. The security actions can include canceling an existing transaction that is in progress, shutting down the media handling device such that is non-operational to perform transactions at the transaction terminal, sending alerts, notifications, or events to a security system, activating a security camera, etc.

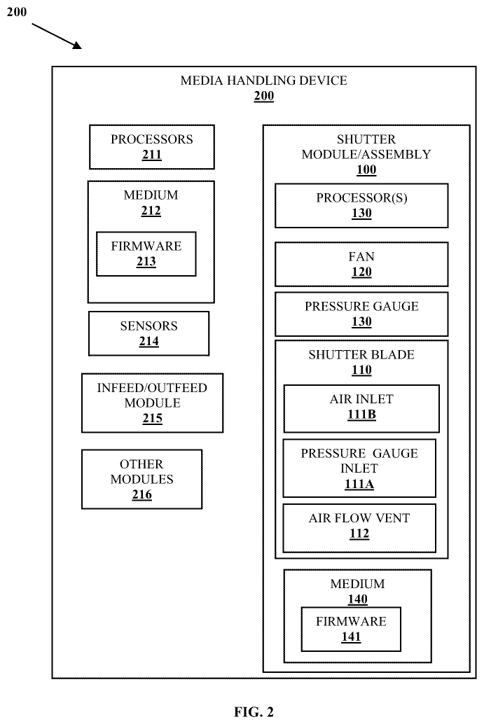

FIG. 2 is a diagram of a media handling device 200 having the shutter module 100, according to an example embodiment. It is to be noted that the components are shown schematically in greatly simplified form, with only those components relevant to understanding of the embodiments being illustrated.

Media handing device 200 includes a one or more processors 211, a non-transitory computer-readable storage medium 212 (hereinafter just “medium”), sensors 214, an infeed/outfeed module 215, other modules 216, and shutter module 100. Medium 212 includes firmware or executable instructions 213, which when provided to processor 211 from medium 212 cause the processor 211 to perform operations discussed herein and below for media handling device 200.

Modules 216 can be any of the above-mentioned modules for a media handling device. Shutter module 100 is attached to infeed/outfeed module 215. Infeed/Outfeed module is associated with deposit/dispense slot as discussed above.

Shutter module 100 includes one or more processors 130, fan 120, pressure gauge 130, medium 140, and shutter blade 110. Blade 100 includes an air inlet 111B, a pressure gauge inlet 111A, and air flow vent 112. Medium 140 includes firmware instructions, which when provided to processor 130 cause processor 130 to perform operations discussed herein and below for shutter module 100.

Pressure gauge 130 is attached to inlet 111A of blade 110 via a tube 131. Similarly fan 120 is attached to inlet 111B of blade 110 via tube 121.

Shutter module 100 can optionally include one or more sensors that notify firmware 141 when the shutter blade 110 is opened or closed. Module 100 may also include other sensors for detecting large foreign objects that may be forced into the aperture associated with the deposit/dispense slot of infeed/outfeed module 215. A sensor of media handling device 200 may also report when blade 110 is opened or closed and/or when a large object is forced into the aperture of the deposit/dispense slot of infeed/outfeed module 215.

Firmware 213 or 141 can cause fan 120 to activate and to deactivate, and firmware 213 or 141 can monitor air pressures within the hollow interior compartment of blade 110 for a range of expected pressures. Firmware 213 or 141 activates fan 120 when blade 110 is opened to force air out of vent 112 and create an air shield around the aperture of deposit/dispense slot for infeed/outfeed module 215 by forcing air in a direction away from the aperture, such that should sand, dust, dirt, or other debris be in the environment of the media handling device it is kept out of the aperture by the air current that is directed away from the aperture.

Firmware 213 can also monitor air pressures within the compartment of blade 110 when blade 110 is in a closed position. When a current air pressure deviates from an expected air pressure, additional security processing or security workflows can be processed by firmware 213. In an embodiment, air pressures are reported by firmware 141 to firmware 213 or obtained by firmware 213 from a log written to by firmware 141. The security operations and workflows are then processed by firmware 213. An unexpected deviation in air pressure within the interior compartment of blade 110 is an indication to firmware 213 that someone may be attempting to tamper with the deposit/dispense slot of infeed/outfeed module 215. In such a case, firmware 213 can process a predefined workflow or process predefined actions, which may include raising a security event to a security system, initiating recording by a camera focused on media handling device 200, shutting down media handling device 200 such that it is not available for any transaction through the transaction terminal, causing an alarm to play over a speaker, etc.

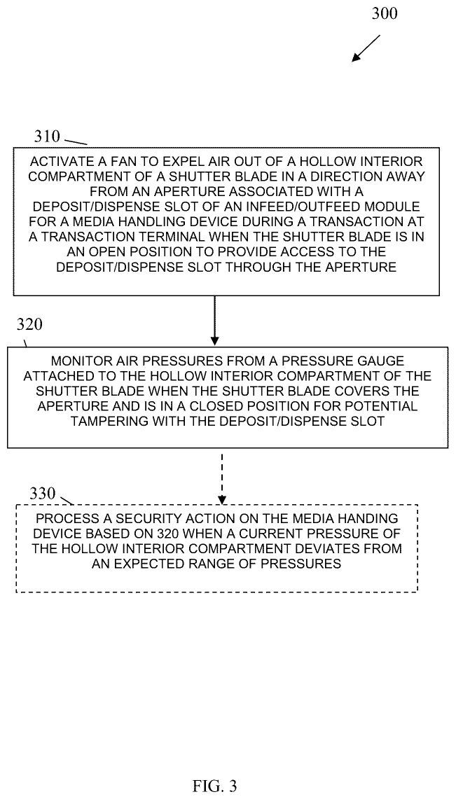

FIG. 3 is a flow diagram of a method 300 for controlling internal enclosure temperatures of a media handling device, according to an example embodiment. The software module(s) that implements the method 300 is referred to as “firmware.” The firmware is implemented as executable instructions programmed and residing within memory and/or a non-transitory computer-readable (processor-readable) storage medium and executed by one or more processors of one or more devices. The processor(s) of the device(s) that executes the firmware are specifically configured and programmed to process the firmware. The firmware may have access to one or more network connections during its processing or the firmware does not have access nor need any network connection during its processing. Any network connection when available to the firmware can be wired, wireless, or a combination of wired and wireless.

In an embodiment, the device that executes the firmware is media handling device 200. In an embodiment, the device that executes the firmware is shutter module 100. In an embodiment, the device that executes the firmware is a transaction terminal; the transaction terminal is an ATM, an SST, a POS terminal, or a kiosk. In an embodiment, the media handling device 200, the shutter blade 100, and the transaction terminal cooperate to execute the firmware on each of the corresponding devices. In an embodiment, the firmware is firmware 213 and/or firmware 141.

At 310, the firmware activates a fan 120 to expel air out of a hollow interior compartment of a shutter blade 110 through an air vent 112 in a directions away from an aperture. The aperture is associated with a deposit/dispense slot of an infeed/outfeed module 215 for a media handling device 200. The fan is activated during a transaction at a transaction terminal when the shutter blade 110 is in an open position to provide access during the transaction to the deposit/dispense slot through the aperture.

At 320, the media handling device monitors air pressures from a pressure gauge 130 attached to the hollow interior compartment of the shutter blade 110 when the shutter blade 110 covers the aperture and is in a closed position for potential tampering with the deposit/dispense slot. This is an indication that someone could be tampering with the deposit/dispense slot when the transaction terminal is in a state indicating that there is no transaction being processed or is in a state during a pending transaction where the shutter blade 110 should not be opened and should be closed.

In an embodiment, at 330, the firmware processes a security action on the media handling device 200 based on the monitoring at 320 when a current pressure of the hollow interior compartment of the shutter blade 110 deviates from an expected range of pressures. The security action can be to disable or shut down the media handling device 200, cancel any pending transaction at the transaction terminal, activate a security camera, sound an audible alarm, flash lights, send messages or events to a security system, etc.

At 320, the firmware instructs the media handling modules 222 to idle their corresponding motors 222-2 by locking the motor drive shafts and running/passing current to the motors 222-2. This creates thermal heat that radiates when the enclosure and causes the current temperature to rise. The firmware instructs the motors 222-2 to idle when the current temperature is detected as being below a first threshold temperature.

At 330, the firmware instructs the media handling modules 222 to stop idling, unlock the corresponding drive shafts, and stop running current to the corresponding motors 222-2. This causes heat to dissipate within the enclosure and the current temperature to fall. The firmware instructs the motors 222-2 to stop idling when the current temperature is detected as being above a second threshold temperature.

In an embodiment, at 340, the firmware monitors internal temperatures for each of the media handling modules 222 and instructs a given media handling module 222 to stop idling the corresponding motor 222-2 when a given internal temperature for the given media handling module 222 exceeds a third threshold temperature. This is an indication that the given module's motor 222-2 is operating at too high of a temperature and needs to be shut down to avoid damage to the motor 222-2.

It should be appreciated that where firmware/software is described in a particular form (such as a component or module) this is merely to aid understanding and is not intended to limit how firmware/software that implements those functions may be architected or structured. For example, modules are illustrated as separate modules, but may be implemented as homogenous code, as individual components, some, but not all of these modules may be combined, or the functions may be implemented in firmware/software structured in any other convenient manner.

Furthermore, although the firmware/software modules are illustrated as executing on one piece of hardware, the firmware/software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A shutter module, comprising:
a shutter blade that comprises:
an interior compartment adapted to hold air within the shutter blade;
an air inlet adapted to provided access to the interior compartment; and
an air vent adapted to expel air out of the interior compartment when the blade is in an open position; and
a fan adapted to pump air into the interior compartment through the air inlet.

2. The shutter module of claim 1, wherein the shutter blade further includes:
a pressure inlet adapted to provide additional access to the interior compartment.

3. The shutter module of claim 2 further comprising:
a pressure gauge adapted to obtain air pressure readings from the interior compartment through the pressure inlet.

4. The shutter module of claim 3, wherein the fan is attached to the air inlet via a first tube that is attached to an air outlet of the fan on a first end of the first tube and that is attached to the air inlet on a second end of the first tube.

5. The shutter module of claim 4, wherein the pressure gauge is attached to the pressure inlet via a second tube that is attached to pressure outlet of the pressure gauge on a first end of the second tube and that is attached to the pressure inlet on a second end of the second tube.

6. The shutter module of claim 1, wherein the air vent is situated on a side of the shutter blade, wherein the side is situated above an aperture for a deposit/dispense slot of a media handling device when the shutter blade is in the open position, wherein the aperture is covered when the shutter blade is in a closed position.

7. The shutter module of claim 1, wherein the air inlet is on a backside of the shutter blade, wherein the backside faces an aperture for a deposit/dispense slot of a media handling device when the shutter blade is in a closed position.

8. The shutter module of claim 1, wherein the shutter blade is adapted to replace an existing shutter blade of an existing shutter module with the fan attached to the air inlet to form the shutter module.

9. The shutter module of claim 1, wherein the shutter module is adapted to be inserted into a media handling device to control access to an aperture associated with a media deposit/dispense slot of a media infeed/outfeed module.

10. The shutter module of claim 1, wherein the shutter blade is adapted to replace an existing shutter blade of an existing shutter module with the fan attached to the air inlet to form the shutter module.

11. A media handling device, comprising:
a media depository/recycler;
a media infeed/outfeed module that comprises a media deposit/dispense slot accessible through an aperture on an outside surface of the media handling device;
a shutter module comprising:
a fan;
a tube; and
a shutter blade comprising:
a hollow interior compartment adapted to house air;
an air vent adapted to expel air from the hollow interior compartment; and
an air inlet adapted to provide access to the hollow interior compartment;
wherein the fan and the air inlet are attached by the tube;
wherein the fan is adapted to force air into the hollow interior compartment of the shutter blade when the shutter blade is in an open position;
wherein the air vent is situated above the aperture for the media deposit/dispense slot of the media infeed/outfeed module when the shutter blade is in the open position to force air provided by the fan air away from the aperture and to present debris from entering the aperture when the shutter blade is in the open position
wherein the shutter blade covers the aperture for the media deposit/dispense slot of the media infeed/outfeed module when the shutter blade in a closed position.

12. The media handling device of claim 11, wherein the shutter blade further includes:
a pressure gauge; and
a pressure inlet adapted to provide access to the hollow interior compartment;
wherein the pressure gauge and the pressure inlet are attached by a second tube.

13. The media handling device of claim 11, wherein the media handling device is configured to monitor pressures of the hollow interior compartment against a range of threshold pressures using the pressure gauge when the shutter blade is in the closed position.

14. The media handling device of claim 13, wherein the media handling device is further configured to process a security action when a current pressure of the hollow interior compartment deviates from the range indicating that the media deposit/dispense slot is potentially being tampered with.

15. The media handling device of claim 13, wherein the media handling device is further configured to activate and deactivate the fan to establish a configured pressure within the hollow interior compartment of the shutter blade when the shutter blade is in the closed position using the pressure gauge.

16. The media handling device of claim 11, wherein the fan is adapted to continuous run and pump air into the hollow interior compartment when the shutter blade is in the open position and when the shutter blade is in the closed position.

17. The media handling device of claim 11, wherein the media handling device is a peripheral to a transaction terminal that performs currency-based transactions.

18. The media handling device of claim 17, wherein the transaction terminal is an automated teller machine, a self-service terminal, a point-of-sale terminal, or a kiosk.

19. A method, comprising:
activating a fan to expel air out of a hollow interior compartment of a shutter blade in a direction that is away from an aperture associated with a deposit/dispense slot of an infeed/outfeed module associated with a media handling device during a transaction at a transaction terminal when the shutter blade is in an open position to provide access to the deposit/dispense slot through the aperture; and
monitoring air pressures from a pressure gauge attached to the hollow interior compartment of the shutter blade when the shutter blade covers the aperture and is in a closed position for potential tampering with the deposit/dispense slot.

20. The method of claim 19 further comprising:
processing a security action on the media handling device based on the monitoring when a current pressure of the hollow interior compartment deviates from an expected range of pressures.
